(19) United States
(12) Patent Application Publication
(10) Pub. No.: US 2008/0040420 A1
(43) Pub. Date: Feb. 14, 2008

(54) Content distribution network

(76) Inventors: Adam Dominic Twiss, Cambridge (GB); David Sinclair Ferguson, Cambridge (GB)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 11/598,130

(22) Filed: Nov. 8, 2006

(30) Foreign Application Priority Data
Aug. 11, 2006 (GB) 0616049.3

(51) Int. Cl. G06F 15/16

(52) U.S. Cl. 709/203

(57) ABSTRACT

The invention relates to a content distribution network for the distribution of a digital object in a peer-to-peer network with a plurality of peers having a peer location identifier and a download client (103a) for downloading the digital object. A of distributed caches (312a, 312b) is present in the peer-to-peer network. At least some of the plurality of peers (102a, 102b, 102c) are connected to at least some of the plurality of distributed caches (312). A private tracker for managing the distribution of the digital object among the plurality of distributed caches (312a, 312b) and a public tracker for managing the distribution of the digital object between the plurality of peers (102a, 102b, 102c) are present.

### FIELD OF THE INVENTION

The present invention relates to the field of peer-to-peer network. More specifically, the present invention relates to a system for content delivery in the peer-to-peer network.

### BACKGROUND TO THE INVENTION

Caches for the intermediate storage of data transferred about the Internet are known in the art. The most common type of cache used in the Internet is a proxy cache. The proxy cache operates at the application level, passing some messages unaltered between a client and a server, changing other ones of the messages and sometimes responding to the messages itself rather than relaying the messages. A web proxy cache sits between web servers and one or more clients and watches requests for HTML pages, music or audio files, video files, image files and data files (collectively known as digital objects) pass through. The web proxy cache saves a copy of the HTML pages, images and files for itself. Subsequently if there is another request for the same object, the web proxy cache will use the copy that was saved instead of asking an origin server to resend the request.

There are three main reasons why web proxy caches are used:

i) In order to reduce latency—in this case, the request is satisfied from the proxy cache (which is closer to the client) instead of the origin server. It therefore takes less time for the client to get the object and display the object. This makes web sites seem more responsive to the client.

ii) To reduce traffic—Each object is only retrieved once from the server once, the proxy cache reduces the amount of bandwidth used by an Internet Service Provider to the outside world and by the client. This saves money if the client is paying for the traffic and keeps the client's bandwidth requirements lower and more manageable.

iii) To increase delivery speed.

The proxy caches may be provided by an Internet Service Provider at an access point and can continually store digital objects accessed by the ISP customers. For example, CacheLogic, Cambridge, UK, provide solutions which can be used by ISPs and other to reduce their traffic. These solutions are documented briefly in the document “the Impact of P2P and the CacheLogic P2P Management Solution” (available 1 Aug. 2006 at http://www.cachelogic.com/products/resource/Intro_CacheLogic_P2P_Mgmt_Solution_v3.0. pdf)

A peer-to-peer (also termed P2P) computer network is a network that relies primarily on the computing power and bandwidth of the participants in the computer network rather than concentrating computing power and bandwidth in a relatively low number of servers. P2P computer networks are typically used for connecting nodes of the computer network via largely ad hoc connections. The P2P computer network is useful for many purposes. Sharing content files containing, for example, audio, video and data is very common. Real time data, such as telephony traffic, is also passed using the P2P network.

A pure P2P network does not have the notion of clients or servers, but only equal peer nodes that simultaneously function as both “clients” and “servers” to the other nodes on the network. This model of network arrangement differs from the client-server model in which communication is usually to and from a central server. A typical example for a non P2P file transfer is an FTP server where the client and server programs are quite distinct. In the FTP server clients initiate the download/uploads and the servers react to and satisfy these requests from the clients.

Some networks and channels, such as Napster, OpenNAP, or IRC@find, use a client-server structure for some tasks (e.g., searching) and a P2P structure for other tasks. Networks such as Gnutella or Freenet use the P2P structure for all purposes, and are sometimes referred to as true P2P networks, although Gnutella is greatly facilitated by directory servers that inform peers of the network addresses of other peers.

One of the most popular file distribution programmes used in P2P networks is currently BitTorrent which was created by Bram Cohen. BitTorrent is designed to distribute large amounts of data widely without incurring the corresponding consumption in costly server and bandwidth resources. To share a file or group of files through BitTorrent, clients first create a “torrent file”. This is a small file which contains meta-information about the files to be shared and about the host computer (the “tracker”) that coordinates the file distribution. Torrent files contain an “announce” section, which specifies the URL of a tracker, and an “info” section which contains (suggested) names for the files, their lengths, the piece length used, and a SHA-1 hash code for each piece, which clients should use to verify the integrity of the data they receive.

The tracker is a server that keeps track of which seeds (i.e. a node with the complete file or group of files) and peers (i.e. nodes that do not yet have the complete file or group of files) are in a swarm (the expression for all of the seeds and peers involved in the distribution of a single file or group of files). Nodes report information to the tracker periodically and from time-to-time request and receive information about other nodes to which they can connect. The tracker is not directly involved in the data transfer and is not required to have a copy of the file. Nodes that have finished downloading the file may also choose to act as seeds, i.e. the node provides a complete copy of the file. After the torrent file is created, a link to the torrent file is placed on a website or elsewhere, and it is normally registered with the tracker. BitTorrent trackers maintain lists of the nodes currently participating in each torrent. The computer with the initial copy of the file is referred to as the initial seeder.

Using a web browser, users navigate to a site listing the torrent, download the torrent, and open the torrent in a BitTorrent client stored on their local machines. After opening the torrent, the BitTorrent client connects to the tracker, which provides the BitTorrent client with a list of clients currently downloading the file or files.

Initially, there may be no other peers in the swarm, in which case the client connects directly to the initial seeder and begins to request pieces. The BitTorrent protocol breaks down files into a number of much smaller pieces, typically a quarter of a megabyte (256 KB) in size. Larger file sizes typically have larger pieces. For example, a 4.37 GB file may have a piece size of 4 MB (4096 KB). The pieces are checked as they are received by the BitTorrent client using a hash algorithm to ensure that they are error free.

As further peers enter the swarm, all of the peers begin sharing pieces with one another, instead of downloading directly from the initial seeder. Clients incorporate mechanisms to optimize their download and upload rates. Peers may download pieces in a random order and may prefer to download the pieces that are rarest amongst it peers, to increase the opportunity to exchange data. Exchange of data is only possible if two peers have a different subset of the file. It is known, for example, in the BitTorrent protocol that a peer initially joining the swarm will send to other members of the swarm a BitField message which indicates an initial set of pieces of the digital object which the peer has available for download by other ones of the peers. On receipt of further ones of the pieces, the peer will send a Have message to the other peers to indicate that the further ones of the pieces are available for download.

One of the challenges in distributing digital objects about the content distribution network implemented as a peer-to-peer network is to ensure that the digital object is distributed accurately and completely in a timely manner and employing the resources (bandwidth etc) in the optimal manner.

### SUMMARY OF THE INVENTION

The invention are solved by providing a content distribution network for the distribution of a digital object in a peer-to-peer network. The peer-to-peer network has a plurality of peers with a peer location identifier and a download client for downloading the digital object. A plurality of distributed caches is provided in the peer-to-peer network and at least some of the plurality of peers are connected to at least some of the plurality of distributed caches. The term distributed cache means that the caches are at different locations. A private tracker manages the distribution of the digital object among the plurality of distributed caches and a public tracker for manages the distribution of the digital object between the plurality of peers.

This allows the efficient distribution of the content through the distributed caches and the peers.

A content server may also connected to the private tracker and to at least one of the plurality of distributed caches is provided. The content server contains a complete copy of the digital object to be distributed. The digital object may be supplied to the content server by a publisher. The peer-to-peer network may have more than one content server which allows the balancing of loads on the network.

A method for the distribution of a digital object over a network to at least one of a plurality of peers is also provided. The method comprises
a first step of placing at least a first piece of the digital object on a content supplier;
a second step of transferring at least the first piece of the digital object to a least one of a plurality of distributed caches;
a third step of announcing the availability of the digital object to at least one of the plurality of peers;
a fourth step of downloading at least the first piece of the digital object to the at least one of the plurality of peers.

The content supplier in this context is either a content server or one of the distributed caches to which the digital object has been already supplied.

This method can allow the announcement of the availability of the digital object is completed prior to the transfer of all of the pieces of the digital object to the content server which substantially speeds up supply of the digital object to the peer-to-peer network.

### DESCRIPTION OF THE DRAWINGS

FIG. 1 shows a Peer-to Peer network as known in the art.

FIG. 2 shows the request for a download of a digital object.

FIG. 3 shows an overview of the network in accordance with the invention.

FIG. 4 shows an overview for the distribution of content.

FIG. 5 shows a geographical implementation of a content distribution network

FIG. 6 shows an overview of a service point of presence.

FIG. 7 shows an overview of a data point of presence.

### DETAILED DESCRIPTION OF THE INVENTION

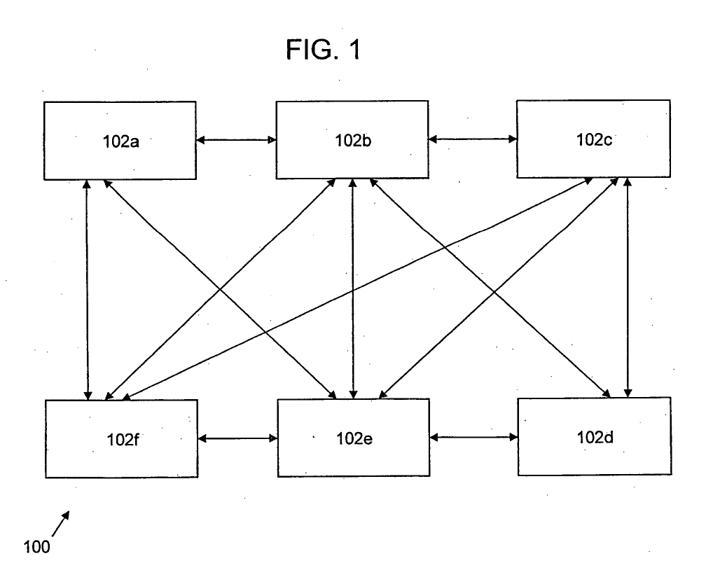

FIG. 1 is a block diagram illustrating an environment in which various embodiments of the invention may be practiced. FIG. 1 includes a Peer-to-Peer (P2P) network 100. The P2P network 100 includes a plurality of peers, such as peer 102a, 102b, 102c, 102d, 102e and 102f, hereinafter referred to as peers 102, connected to each other. P2P network 100 may be a Local Area Network (LAN), a Wide Area Network (WAN), a Metropolitan Area Network (MAN), a wireless network and the like. The peers 102 present in the P2P network 100 include stored digital data. Various examples of the digital data include, but are not limited to, an application file, a video file, a music file and the like. In P2P network 100 the digital data is shared among the peers 102. It should be understood that the peers 102 may store multiple copies of the digital data.

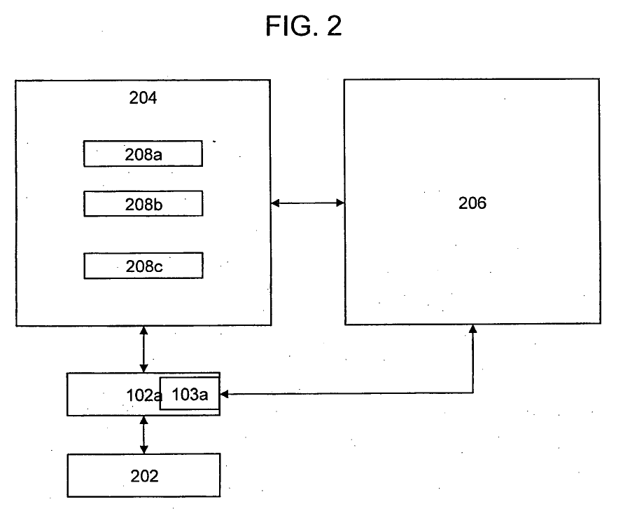

FIG. 2 is a block diagram illustrating a user 202 sending a request for download of a digital object through peer 102a, in accordance with an example of the invention. FIG. 2 includes the peer 102a, a download client 103a running on the peer 102a, the user 202, a server 204 and a tracker server 206. The server 204 may include one or more torrent files, such as torrent file 208a, 208b and 208c, hereinafter referred to as the torrent files 208. The present invention has been described with respect to BitTorrent protocol as an example. It should be understood by those skilled in the art that present invention is applicable to all P2P protocols.

The user 202 makes a request at the peer 102a to download the digital object. The peer 102a communicates with the server 204 and provides information for the digital object to be downloaded to the server 204. Subsequently, the server 204 locates one of the torrent files related to the digital object requested for download by peer 102a, such as, for example, torrent file 208a. The torrent files 208 may include information related to the name, size, number of pieces and check sum error for the digital object to be downloaded by peer 102a.

Subsequently, the tracker server 206 can provide a list of peers 102 present in the P2P network 100 with the pieces of the digital object to be downloaded. The peer 102a, thereafter, communicates with the available list of peers 102 for downloading the related digital objects. The peer 102a communicates with peers 102 by sending a bit field of the pieces of the digital object that peer 102a has. After peer 102a receives all the bitfields from peers 102, it sends a message to the peers 102 where it finds relevant data and starts downloading the pieces of the requested digital object.

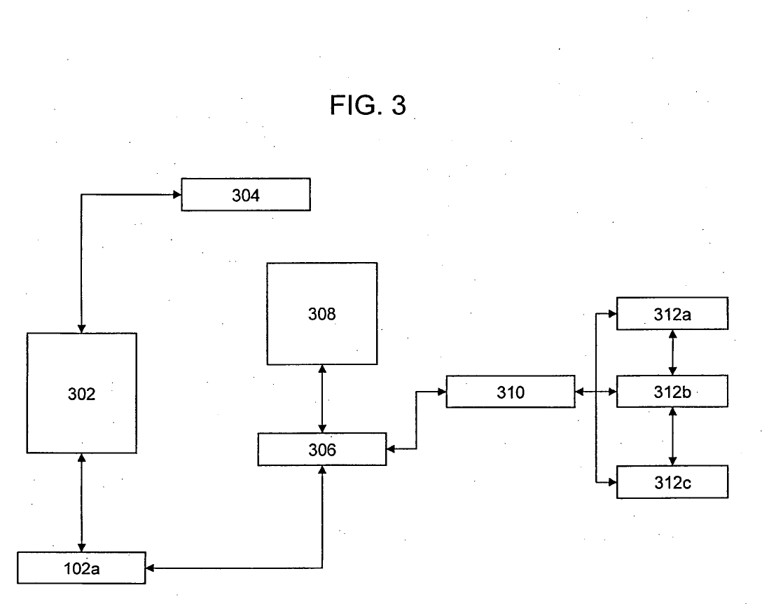

FIG. 3 is a block diagram illustrating peer 102a in communication with a Cache Location Server (CLS) 302, in accordance with an example of the present invention. FIG. 3 includes the peer 102a, the CLS 302, a database 304, an Internet Service Provider Domain Name Server (ISP DNS) 306, a central Domain Name Server (central DNS) 308, a cache DNS 310 and one or more caches, such as, cache 312a, 312b and 312c, hereinafter referred to as caches 312.

The peer 102a communicates with the CLS 302. The information sent by the peer 102a to the CLS 302 may also contain the IP address of the peer 102a. Based on the received information, the CLS 302 communicates a location string to the peer 102a. The CLS 302 may get the location string from the database 304. The database 304 stores information about the IP address ranges of countries, ISPs, regions, towns, etc for the purpose of generating specific location strings with respect to peers 102.

The peer 102a then, using the location string and information from the Torrent File 208, makes communication with the ISP DNS 306.

The information sent by peer 102a to ISP DNS 306 may be as following:

Protocol-TruncatedHash.Protocol-Publisher-LocationString.Find-Cache.com An example of the information sent by CLS 302 to peer 102a may be as following:

bt-1234.bt-bigcorp-bigispnyc.find-cache.com

where, ‘bt’ represents the BitTorrent protocol used by the peer 102a, ‘1234’ representing a specific hash value associated with the digital object to be downloaded by the peer 102a, ‘bigcorp’ representing the publisher (a fictional “Big Corporation”) of the digital object to be downloaded, ‘bigispnyc’ representing the location string for the peer 102a (the New York point of presence for a fictional “Big ISP”).

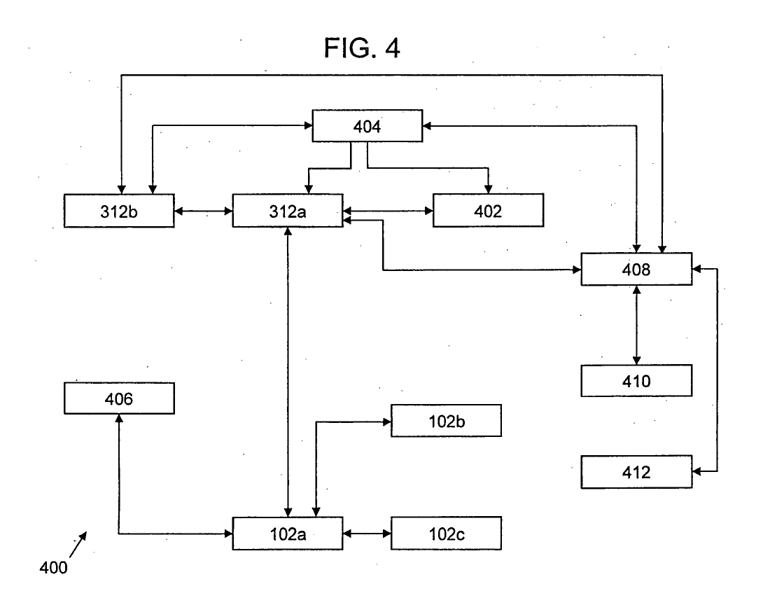

Based on this communication, the ISP DNS 306 redirects the request to the central DNS 308 (which is the name server for the domain contained in the communication). Thereafter, the central DNS 308 provides an address of the cache DNS 310 to the ISP DNS 306. The cache DNS 310, thus, receives a DNS request from the ISP DNS 306 for the digital object to be downloaded. Subsequently, the cache DNS 310 allocates one of the caches 312, such as, for example, cache 312a. The cache DNS 310 may allocate one of the caches 312 based on the load, availability and content on each of them. The cache DNS 310 communicates this information to the ISP DNS 306, which in turn communicates the information to the peer 102a. The peer 102a, thereafter, makes a communication with the cache 312a for downloading the digital object. The communication between the peer 102a and cache 312a is explained in detail in FIG. 4.

FIG. 4 is a block diagram illustrating a system 400 for content distribution in the P2P network 100. The system 400 includes the peer 102a, 102b and 102c, the cache 312a and 312b, a content server 402, a private tracker 404, a public tracker 406, a business logic unit 408, a central database server 410 and a user interface unit 412.

The peer 102a sends a request to the cache 312a for downloading the digital object. The cache 312a is connected to the content server 402 and the private tracker 404. The content server 402 can include complete copies of a plurality of stored digital objects in the P2P network 100. The content server 402 may be connected to a publisher's computer network. The content server 402 receives the digital objects, which are to be distributed, from the publisher's computer network. For example, the publisher wishing to distribute a video file in the P2P network 100 would first upload the video file to the content server 402. Thereafter, the video file can be subsequently downloaded by the peers 102 from the content server 402.

As soon as the publisher uploads a piece of the digital object on the content server 402, the digital data can become available for the peers 102 to be downloaded. Thus, as the publisher progresses with the upload of subsequent pieces of the digital object, the peers 102 are able to download those uploaded pieces in parallel. Therefore, the capability of the system 400 to execute parallel uploads and downloads of the digital object from the content server 402 ensures an efficient real time availability of digital objects in the P2P network 100.

The cache 312a downloads the digital objects, based on the request from the peer 102a, from the content server 402. 402 or from cache 312b. The private tracker 404 knows which of the digital objects are available on which of the caches 312 and content servers 402 and provides this information to the cache 312a. If the digital object requested by the peer 102a is available on the cache 312a, the peer 102a downloads the digital object from the cache 312a. If the digital object is not available on the cache 312a, the cache 312a downloads the requested digital object from the content server 402 and/or the cache 312b. Thereafter, the cache 312a makes the digital object available to the peer 102a for downloading. The peer 102a may also download the related digital objects from the other peers 102 available in the P2P network 100, such as, for example, peer 102b and peer 102c.

The cache 312a may upload digital objects from the peers 102 available in the P2P network 100. In such a case, the cache 312a acts as one of the peers 102.

As discussed above, the private tracker 404 maintains a track of all the data available on the content server 402 and the caches 312. The public tracker 406 is connected to all of the caches 312 and to all of the peers 102 in the P2P network 100. The public tracker 406 maintains a track of all the data digital objects transferred among the caches 312 and the peers 102. In particular, the public tracker 406 maintains a list of all of the peers 102 and the caches 312 which hold copies of the digital objects available in the P2P network 100.

The business logic unit 408 is connected to all the caches 312 and the private tracker 404. The business logic unit 408 authenticates peers 102 before allowing the peers 102 to upload any digital object. Further, the business logic unit 408 is connected to the central database server 410. The business logic unit 408 acts as an interface between the P2P network 100 and the central database server 410. Central database server 410 acquires log reports from the private tracker 404 and caches 312, through the business logic unit 408, for all the data transferred to and from the caches 312 and the content server 402. Using the information from the central database server 410 obtained via the business logic unit 408, such as, the log reports, the user interface unit 412 provides the required information billing purposes and for report generation.

The central database server 410 may be connected to the public tracker 406. The public tracker 406 may be connected to the private tracker 404.

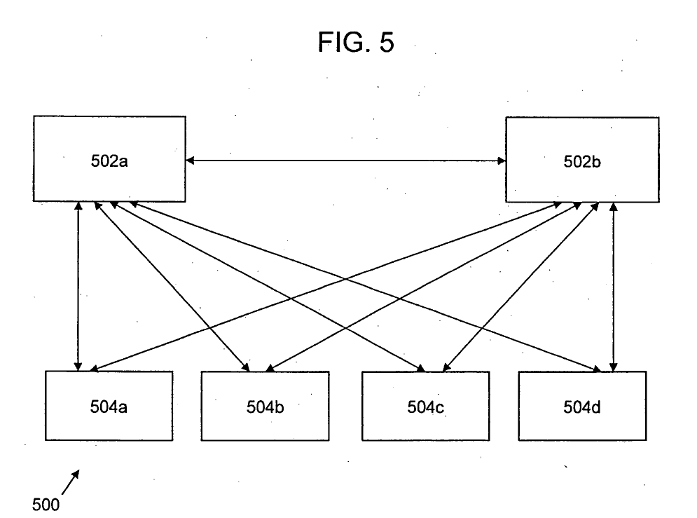

FIG. 5 is a block diagram illustrating an exemplary geographical implementation of a cache distribution network 500. The cache distribution network 500 includes one or more service points of presence, such as, a service point of presence 502a and 502b, hereinafter referred to as the service points of presence (POPs) 502. The cache distribution network 500 further includes one or more data points of presence, such as, data point of presence 504a, 504b, 504c and 504d, hereinafter referred to as data points of presence (POPs) 504. The service POPs 502 are located at remote geographical locations for, such as, for example London, San Jose and so forth. It should be understood by those skilled in art that the number of the service POPs 502 locations are scalable and may be increased with the increase in network traffic. The service POPs 502, such as the service POP 502a and 502b, are connected to each other. The connection between the service POPs 502 enables a real time data and information transfer between all of the service POPs 502,

Furthermore, the data POPs 504 are also located in remote geographical locations across the globe, such as, for example, New York, Frankfurt and so forth. It should be understood by those skilled in art that the number of the data POPs 504 locations are scalable and may be increased with the increase in network traffic and digital objects available in the P2P network 100. The data POPs 504, such as the data POP 504a and 504b, are connected with all the available service POPs 502 in the P2P network 100. The connection between the data POPs 504 and service POPs 502 enables a real time data update and information transfer between the data POPs 504 from the service POPs 502, The geographical location may include both, the service POP 502a and the data POP 504a.

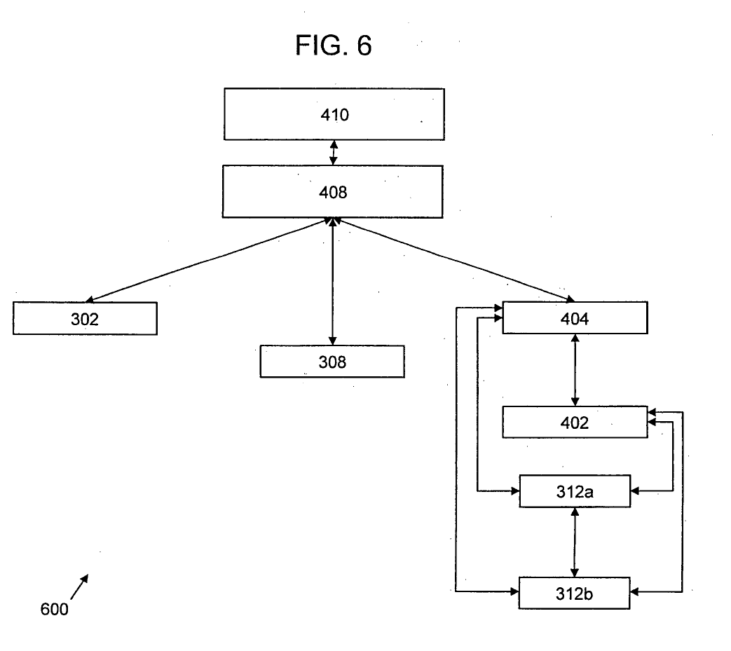

FIG. 6 is a block diagram illustrating an arrangement 600 of the components of the service POP 502a, in accordance with an example of the present invention. The arrangement 600 for the service POP 502a includes the cache location server 302, the central domain name server 308, the content server 402, the private tracker 464, the business logic unit 408 and the central database server 410. Further, the arrangement 600 for the service POP 502a can include the caches 312, such as, the cache 312a and 312b. Furthermore, the arrangement 600 for the service POP 502a can include the public tracker 406, the business logic unit 408 and the user interface unit 412.

The central database server 410 can be located in each of the service POPs 502. The central database server 410 of each of the service POPs 502 are connected to each other and act as a central database unit.

It should be understood by those skilled in the art that the components illustrated in the arrangement 600 for the service POP 502a are scalable and may be increased based on the network traffic and the digital objects available in the P2P network 100.

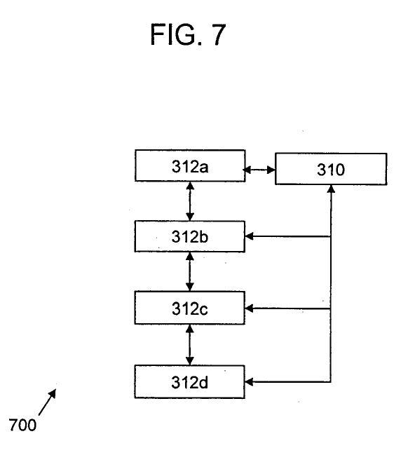

FIG. 7 is a block diagram illustrating an arrangement 700 of the components of the data POP 504a, in accordance with an example of the present invention. The arrangement 700 for the data POP 504a includes the caches 312, such as, the cache 312a, 312b, 312c and 312d and the cache DNS 310. Only a single cache DNS 310 is shown in FIG. 7 for simplicity. However, the data POP 504a may contain more than one of the single caches DNS 310. The data POP 504a provides digital objects for the peers 102 in the P2P network 100. The data POPs 504 download data from the service POPs 502.

It should be understood by those skilled in the art that the components illustrated in the arrangement 700 for the data POP 504a are scalable and may be increased based on the network traffic and the digital objects available in the P2P network 100.

The foregoing description is that of the preferred embodiments of the invention and that various changes and modifications may be made thereto without departing from the spirit and scope of the invention.

1. Content distribution network for the distribution of a digital object comprising:
a plurality of peers, at least some of the plurality of peers being connected to at least some of the others of the plurality of peers and having a peer location identifier and a download client for downloading the digital object;
a plurality of distributed caches, whereby at least some of the plurality of peers are connected to at least some of the plurality of distributed caches;
a private tracker for managing the distribution of the digital object among the plurality of distributed caches;
a public tracker for managing the distribution of the digital object between the plurality of peers.

2. The content distribution network of claim 1, further comprising at least one first content server and connected to the private tracker and at least one of the plurality of distributed caches for distributing content to the plurality of distributed caches.

3. The content distribution network of claim 2, further comprising a further content server at a location remote from the first content server.

4. The content distribution network of claim 1 further comprising a cache location server connected to at least some of the plurality of peers for providing the at least some of the plurality of peers with a cache location identifier of one or more of the plurality of distributed caches.

5. The content distribution network of claim 1 wherein the content server maintains a complete copy of the digital object.

6. A method for the distribution of a digital object over a network to at least one of a plurality of peers comprising:
placing at least a first piece of the digital object on a content supplier;
transferring at least the first piece of the digital object to a least one of a plurality of distributed caches;
announcing the availability of the digital object to at least one of the plurality of peers;
downloading at least the first piece of the digital object to the at least one of the plurality of peers.

7. The method of claim 6, wherein announcing the availability of the digital object is completed prior to the transfer of all of the pieces of the digital object to the content server.

8. The method of claim 6, wherein the at least one of the plurality of peers uploads at least the first piece of the digital object to a further cache.

9. The method of claim 6, wherein the at least one of the plurality of peers provides at least the first piece of the digital object to a further one of the plurality of peers.

10. The method of claim 6 further managing the distribution of the digital object among the plurality of distributed caches by a private tracker.
